(19) United States
(12) Patent Application Publication
(10) Pub. No.: US 2018/0277295 A1
(43) Pub. Date: Sep. 27, 2018

(54) IRON CORE INCLUDING FIRST IRON CORE BLOCK AND SECOND IRON CORE BLOCK

(71) Applicant: FANUC CORPORATION, Yamanashi (JP)

(72) Inventor: Masatomo SHIROUZU, Yamanashi (JP)

(21) Appl. No.: 15/922,231

(22) Filed: Mar. 15, 2018

(30) Foreign Application Priority Data
Mar. 21, 2017 (JP) 2017-054731

(51) Int. Cl. H01F 27/245; H01F 3/14; H01F 3/02; H01F 41/02; H01F 41/08; H01F 27/30

(52) U.S. Cl. CPC H01F 27/245; H01F 3/14; H01F 27/306; H01F 41/0233; H01F 41/08; H01F 3/02

(57) ABSTRACT

An iron core includes a first iron core block and second iron core blocks. The first iron core block includes recessed portions. The second iron core blocks include projection portions. The recessed portions and the projection portions can be fitted with each other. The second iron core blocks are disposed inside the ring-shaped first iron core block. Coils are wound onto the second iron core blocks.

### BACKGROUND OF THE INVENTION

### 1. Field of the Invention

The present invention relates to an iron core including a first iron core block and a second iron core block.

### 2. Description of Related Art

In conventional techniques, to assemble an iron core from two adjoining iron core blocks, the iron core blocks may be secured with an adhesive or by screwing. A gap member may be inserted between the two iron core blocks, and the iron core blocks may be secured with an adhesive (for example, refer to Japanese Unexamined Patent Publication (Kokai) No. 2010-118496).

### SUMMARY OF THE INVENTION

However, adhesives, screws, and the like have thermal expansion coefficients which are different from iron core blocks. Thus, a secured portion between two iron core blocks may deteriorate with long-term use. In such an instance, the two iron core blocks of the iron core may generate vibration or noise.

Therefore, it is desired to provide an iron core that does not generate vibration or noise, even with long-term use.

A first aspect of this disclosure provides an iron core including a first iron core block and a second iron core block. The first iron core block and the second iron core block include a recessed portion and a projection portion, respectively, which can be fitted with each other.

According to the first aspect, the first iron core block and the second iron core block are fitted with each other using the recessed portion and the projection portion, without the need for using an adhesive, a screw, or the like. In other words, a member having a different thermal expansion coefficient can be omitted. Therefore, a secured portion between the two iron core blocks does not deteriorate, even with long-term use, and it is therefore possible to prevent the occurrence of vibration or noise.

The above objects, features and advantages and other objects, features and advantages of the present invention will become more apparent from the following detailed description of preferred embodiments along with the accompanying drawings.

### BRIEF DESCRIPTION OF THE DRAWINGS

FIG. 1A is a cross-sectional view of a reactor including an iron core according to a first embodiment;

FIG. 1B is a perspective view of the reactor shown in FIG. 1A;

FIG. 2 is a cross-sectional view of a reactor including an iron core according to a second embodiment;

FIG. 3 is a top view of a reactor including an iron core according to a third embodiment;

FIG. 4 is a cross-sectional view of a reactor including an iron core according to a fourth embodiment;

FIG. 5 is a cross-sectional view of a reactor including an iron core according to a fifth embodiment; and

FIG. 6 is a cross-sectional view of a three-phase reactor including an iron core according to a sixth embodiment.

### DETAILED DESCRIPTION OF THE INVENTION

Embodiments of the present invention will be described below with reference to the accompanying drawings. In the drawings, the same reference numerals indicate the same components. For ease of understanding, the scales of the drawings have been modified in an appropriate manner.

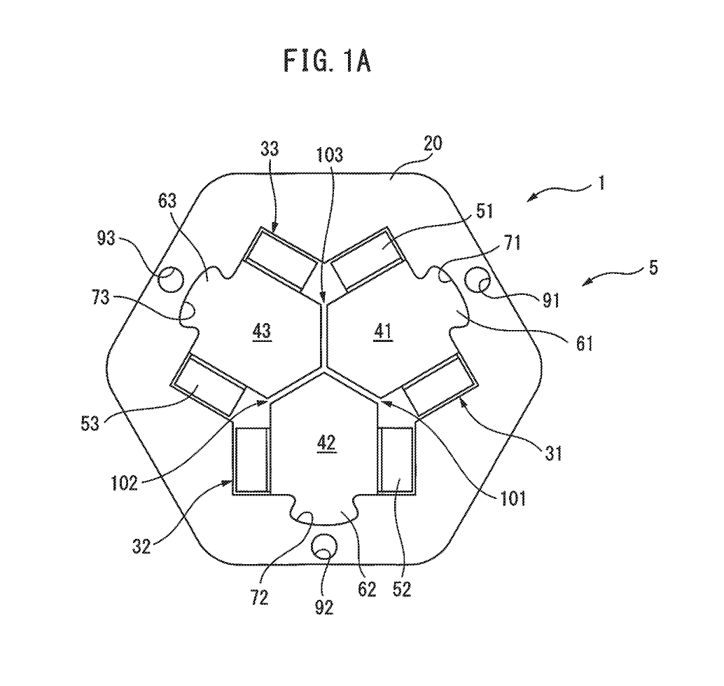

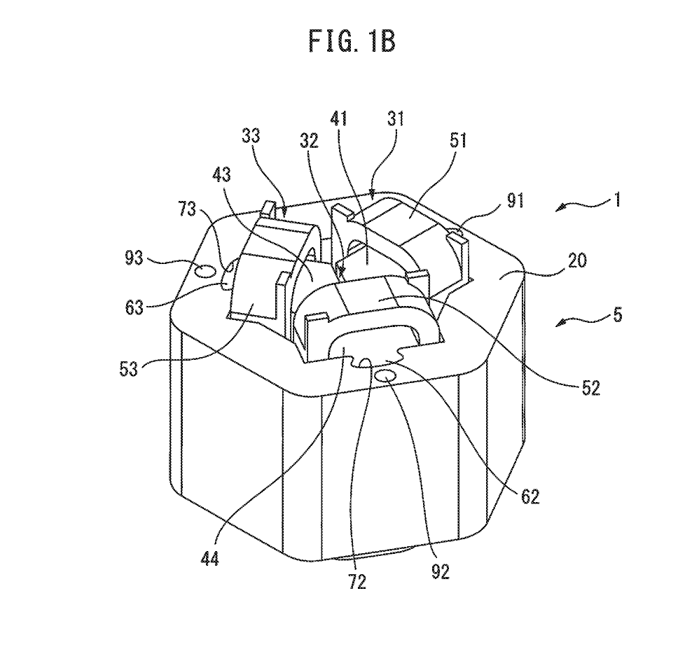

FIG. 1A is a cross-sectional view of a reactor including an iron core according to a first embodiment. FIG. 1B is a perspective view of the reactor shown in FIG. 1A. As shown in FIGS. 1A and 1B, a reactor 5 includes a ring-shaped outer peripheral core 20 having a hexagonal cross-section, and at least three core coils 31 to 33 contacting or connected to an inner surface of the outer peripheral core 20. The outer peripheral core 20 may have a round shape or another polygonal shape.

The core coils 31 to 33 include cores 41 to 43 and coils 51 to 53 wound onto the cores 41 to 43, respectively. Each of the outer peripheral core 20 and the cores 41 to 43 is made by stacking iron sheets, carbon steel sheets, electromagnetic steel sheets, or amorphous sheets, or made of a magnetic material such as a pressed powder core or ferrite. The number of the core coils 31 to 33 may be an integral multiple of 3, and thereby the iron core assembly constituted of the outer peripheral core 20 and the cores 41 to 43 can compose a three-phase reactor.

Furthermore, the cores 41 to 43 converge toward the center of the outer peripheral core 20 at their radial inner end portions, each having an edge angle of approximately 120°. The radial inner end portions of the cores 41 to 43 are separated from each other by gaps 101 to 103, which can be magnetically coupled. In other words, in the first embodiment, the radial inner end portion of the core 41 is separated from the radial inner end portions of the two adjacent cores 42 and 43 by the gaps 101 and 103, respectively. The same is true for the other cores 42 and 43. Furthermore, the cores 41 to 43 have the same dimensions as each other, and are arranged at equal intervals in the circumferential direction of the outer peripheral core 20.

Note that, the gaps 101 to 103 ideally have the same dimensions, but may have different dimensions. In the embodiments described later, a description regarding the gaps 101 to 103, the core coils 31 to 33, and the like may be omitted.

As described above, in the first embodiment, the core coils 31 to 33 are disposed inside the outer peripheral core 20. In other words, the core coils 31 to 33 are enclosed within the outer peripheral core 20. The outer peripheral core 20 can reduce leakage of magnetic flux generated by the coils 51 to 53 to the outside.

The cores 41 to 43 integrally have projection portions 61 to 63 at their radial outer end portions, respectively. Each of the projection portions 61 to 63 preferably has a constriction having a narrower width than its proximal end and distal end. The same is true for the other projection portions described later. Furthermore, the outer peripheral core 20 has recessed portions 71 to 73 into which the projection portions 61 to 63 can be fitted. The recessed portions 71 to 73 and the projection portions 61 to 63 extend in the stacking direction. In the structure shown in FIG. 1A, the outer peripheral core 20 is preferably a single member formed by stacking a plurality of non-oriented magnetic steel sheets, and the cores 41 to 43 are preferably formed by stacking a plurality of oriented magnetic steel sheets.

In the structure shown in FIG. 1A, the outer peripheral core 20 is first prepared. Then, the coils 51 to 53 are wound onto the cores 41 to 43, respectively. Thereafter, the projection portion 61 of the core 41 having the coil 51 is fitted into the recessed portion 71 of the outer peripheral core 20 in the stacking direction, to attach the core 41 to the outer peripheral core 20. Thereafter, the core 42 having the coil 52 and the core 43 having the coil 53 are sequentially attached to the outer peripheral core 20, in the same manner. Therefore, the reactor 5 having the iron core assembly constituted of the cores 41 to 43 and the outer peripheral core 20, as shown in FIG. 1A, is made.

In this instance, the cores 41 to 43 (second iron core blocks) are fitted into the outer peripheral core 20 (first iron core block) using the recessed portions 71 to 73 and the projection portions 61 to 63, without the need to use an adhesive, screws, or the like. In other words, a member having a different thermal expansion coefficient can be omitted. Therefore, it is possible to prevent the occurrence of vibration or noise from the outer peripheral core 20 and the cores 41 to 43, even with long-term use.

Furthermore, in the structure shown in FIG. 1A, since the outer peripheral core 20 is constituted of a single member, the outer periphery of the outer peripheral core 20 need not be clamped, and thus the gaps 101 to 103 do not change after assembly. Note that, projection portions may be formed in the outer peripheral core 20, and recessed portions into which the projection portions can be inserted may be formed in the cores 41 to 44. The same is true for the embodiments described later.

As shown in FIG. 1A, through holes 91 to 93 are formed in the outer peripheral core 20. The through holes 91 to 93 are formed in positions corresponding to the cores 41 to 43, in other words, positions adjacent to the recessed portions 71 to 73 and the projection portions 61 to 63, respectively.

Into the through holes 91 to 93 (94), bolts, rods, or the like (not illustrated) are inserted. Thus, the outer peripheral core 20 (first iron core block) can be firmly secured in the stacking direction (axial direction) in the vicinities of the recessed portions 71 to 73 and the projection portions 61 to 63. This has an advantage, in particular, when the radial thickness of the outer peripheral core 20 is partially reduced owing to the recessed portions 71 to 73 formed in the outer peripheral core 20, as shown in FIG. 1A.

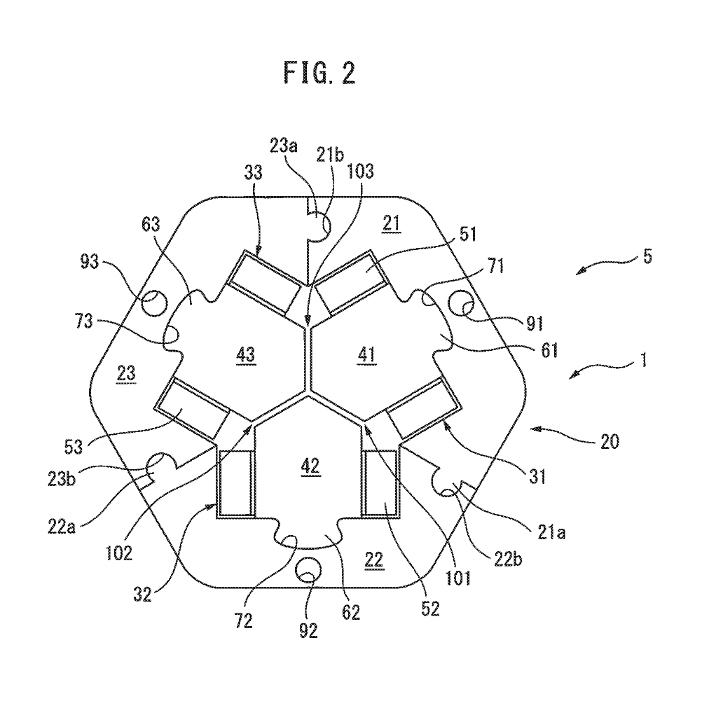

FIG. 2 is a cross-sectional view of a reactor including an iron core according to a second embodiment. In FIG. 2, a ring-shaped outer peripheral core 20 is constituted of outer peripheral core members 21 to 23 joined to each other. In other words, the outer peripheral core 20 is constituted of a plurality of, for example, three outer peripheral core members 21 to 23.

Cores 41 to 43 are disposed in positions corresponding to the centers of the outer peripheral core members 21 to 23, respectively. The outer peripheral core members 21 to 23 have projection portions 21a to 23a that are integrally formed at one ends of the outer peripheral core members 21 to 23 in the circumferential direction, respectively. At the other ends of the outer peripheral core members 21 to 23, recessed portions 21b to 23b into which the projection portions 21a to 23a can be fitted are formed, respectively. In the structure of FIG. 2 and the embodiments described later, each of the outer peripheral core members 21 to 23 and the cores 41 to 43 is preferably made by stacking a plurality of oriented magnetic steel sheets. Otherwise, a plurality of non-oriented magnetic steel sheets may be used only in the vicinities of proximal ends of the cores 41 to 43.

In the structure shown in FIG. 2, the projection portion 21a of the outer peripheral core member 21 is fitted into the recessed portion 22b of the outer peripheral core member 22. In the same manner, the projection portion 22a of the outer peripheral core member 22 is fitted into the recessed portion 23b of the outer peripheral core member 23, and the projection portion 23a of the outer peripheral core member 23 is fitted into the recessed portion 21b of the outer peripheral core member 21. The outer peripheral core 20 is assembled thereby. Thereafter, the cores 41 to 43 having coils 51 to 53 are sequentially attached to the outer peripheral core 20, as described above, to assemble a reactor 5.

In such an instance, substantially the same effects as described above can be obtained. Furthermore, in the second embodiment, since the outer peripheral core 20 is constituted of the outer peripheral core members 21 to 23, the outer peripheral core 20 can be easily produced, even if the outer peripheral core 20 is large in size. Since the outer peripheral core 20 is assembled using the projection portions 21a to 23a and the recessed portions 21b to 23b, misalignment between the outer peripheral core members 21 to 23 of the outer peripheral core 20 can be prevented after assembly. When the outer peripheral core members 21 to 23 (28) are assembled to each other, each of the outer peripheral core members 21 to 23 (28) can be either of a first iron core block and a second iron core block.

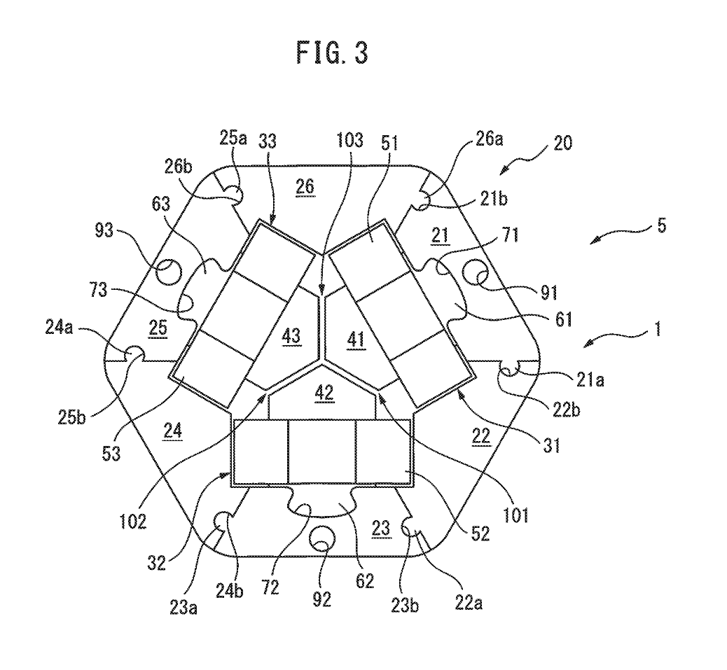

FIG. 3 is a top view of a reactor including an iron core according to a third embodiment. In FIG. 3, a ring-shaped outer peripheral core 20 is constituted of outer peripheral core members 21 to 26 connected to each other. In other words, the outer peripheral core 20 is constituted of a plurality of, for example, six outer peripheral core members 21 to 26.

Cores 41 to 43 are disposed in positions corresponding to the centers of the outer peripheral core members 21, 23, and 25, respectively. The outer peripheral core members 22, 24, and 26, which are not engaged with the cores 41 to 43, and the outer peripheral core members 21, 23, and 25 are arranged in an alternate manner. The outer peripheral core members 21 to 26 have projection portions 21a to 26a that are integrally formed at one ends of the outer peripheral core members 21 to 26 in the circumferential direction, respectively. At the other ends of the outer peripheral core members 21 to 26, recessed portions 21b to 26b into which the projection portions 21a to 26a can be fitted are formed, respectively.

The assembly method of a reactor 5 shown in FIG. 3 is the same as above, so a description thereof is omitted. In this instance, the same effects as described above can be obtained. Furthermore, each of the outer peripheral core members 21 to 26 according to the third embodiment has smaller dimensions than each of the outer peripheral core members 21 to 23 according to the second embodiment. Thus, each of the outer peripheral core members 21 to 26 has reduced weight, thus allowing ease of handling. Therefore, the third embodiment contribute to easy assembly of the larger-sized outer peripheral cores 20.

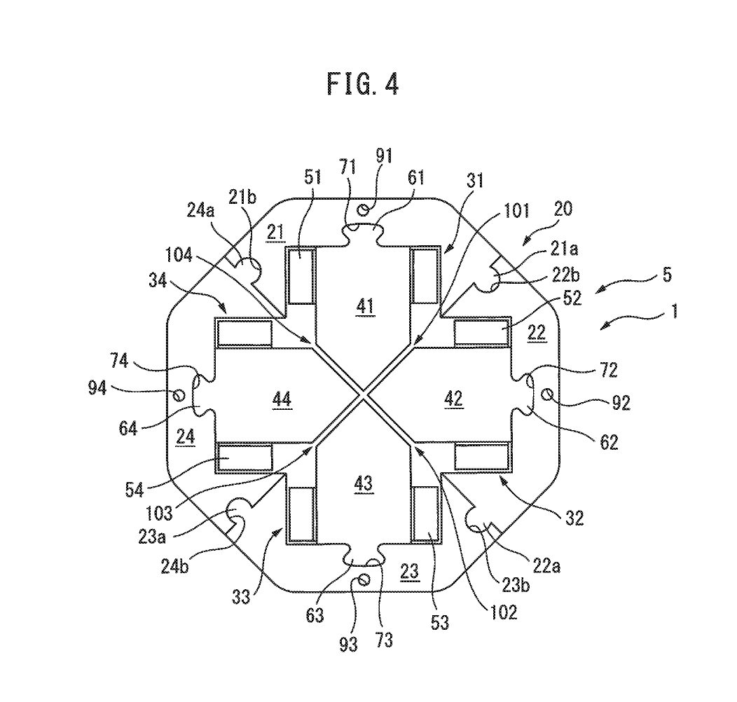

FIG. 4 is a cross-sectional view of a reactor including an iron core according to a fourth embodiment. A reactor 5 shown in FIG. 4 includes an approximately octagonal-shaped outer peripheral core 20 and four core coils 31 to 34, which are similar to above, disposed inside the outer peripheral core 20. The core coils 31 to 34 are arranged at equal intervals in the circumferential direction of the reactor 5. The number of the cores 41 to 44 is preferably an even number of 4 or more, and thereby the reactor 5 including the iron core assembly constituted of the outer peripheral core 20 and the cores 41 to 44 can be used as a single-phase reactor.

In FIG. 4, the ring-shaped outer peripheral core 20 is constituted of outer peripheral core members 21 to 24 joined to each other. In other words, the outer peripheral core 20 is constituted of a plurality of, for example, four outer peripheral core members 21 to 24.

As is apparent from the drawing, the core coils 31 to 34 include cores 41 to 44 and coils 51 to 54 wound onto the cores 41 to 44, respectively. Radial inner end portions of the cores 41 to 44 are situated in the vicinity of the center of the outer peripheral core 20. In FIG. 4, the cores 41 to 44 converge toward the center of the outer peripheral core 20 at their radial inner end portions, each having an edge angle of approximately 90°. The radial inner end portions of the cores 41 to 44 are separated from each other by gaps 101 to 104, which can be magnetically coupled.

In the same manner as above, the cores 41 to 44 integrally have projection portions 61 to 64 at their radial outer end portions, respectively. In the outer peripheral core 20, recessed portions 71 to 74 into which the projection portions 61 to 64 can be fitted are formed. Furthermore, the outer peripheral core members 21 to 24 have projection portions 21a to 24a that are integrally formed at one ends of the outer peripheral core members 21 to 24 in the circumferential direction, respectively. At the other ends of the outer peripheral core members 21 to 24, recessed portions 21b to 24b into which the projection portions 21a to 24a can be inserted are formed, respectively.

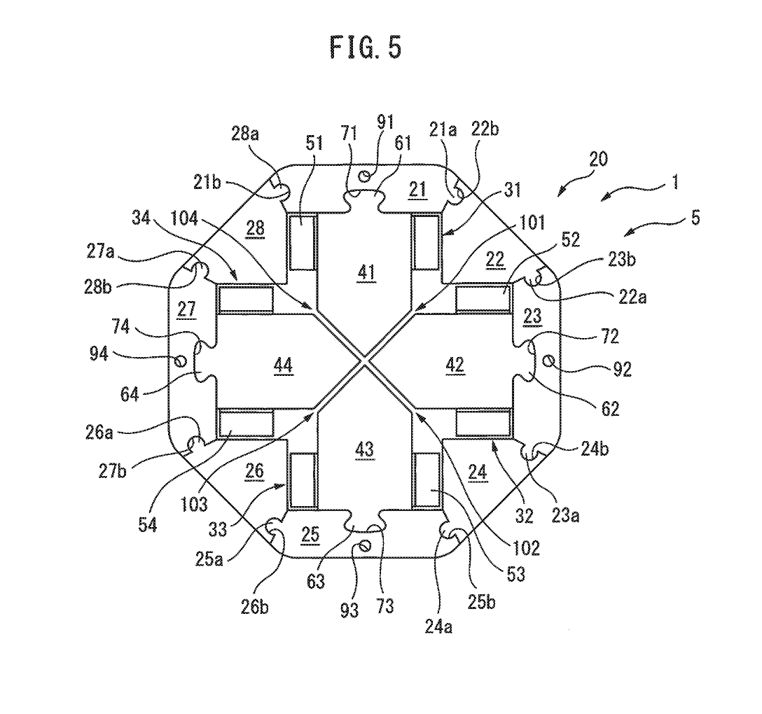

FIG. 5 is a cross-sectional view of a reactor including an iron core according to a fifth embodiment. In FIG. 5, a ring-shaped outer peripheral core 20 is constituted of outer peripheral core members 21 to 28 joined to each other. In other words, the outer peripheral core 20 is constituted of a plurality of, for example, eight outer peripheral core members 21 to 28.

Cores 41 to 44 are disposed in positions corresponding to the centers of the outer peripheral core members 21, 23, 25, and 27 respectively. The outer peripheral core members 22, 24, 26, and 28, which are not engaged with the cores 41 to 44, and the outer peripheral core members 21, 23, 25, and 27 are arranged in an alternate manner. The outer peripheral core members 21 to 28 have projection portions 21a to 28a that are integrally formed at one ends of the outer peripheral core members 21 to 28 in the circumferential direction, respectively. At the other ends of the outer peripheral core members 21 to 28, recessed portions 21b to 28b into which the projection portions 21a to 28a can be fitted are formed, respectively.

The assembly method of the reactors 5 shown in FIGS. 4 and 5 is the same as above, so a description thereof is omitted. In these instances, the same effects as described above can be obtained.

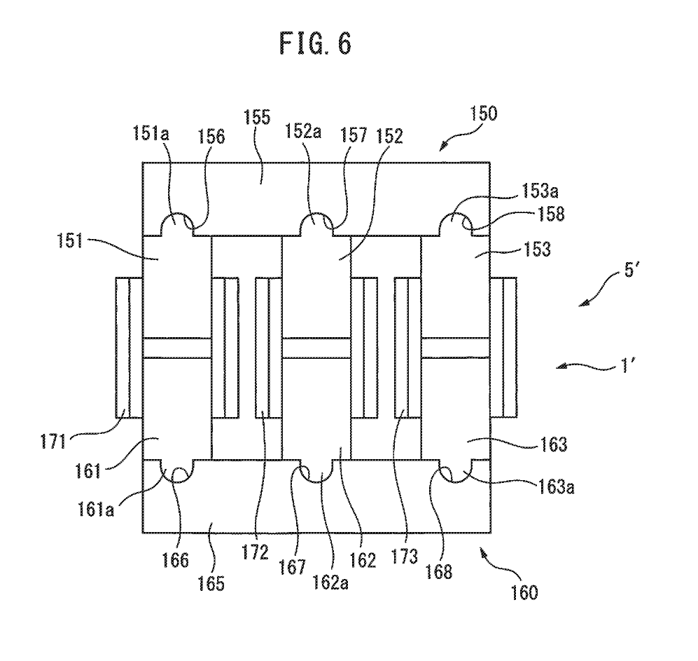

FIG. 6 is a cross-sectional view of a three-phase reactor including an iron core according to a sixth embodiment. As shown in FIG. 6, a three-phase reactor 5′ includes an approximately E-shaped first core 150 and an approximately E-shaped second core 160. The first core 150 includes a plurality of, for example, three first leg members 151 to 153 and a first support member 155 joined to the first leg members 151 to 153. The second core 160 includes a plurality of, for example, three second leg members 161 to 163 and a second support member 165 joined to the second leg members 161 to 163. The first core 150 and the second core 160 constitute an iron core assembly 1′.

The first leg members 151 to 153 of the first core 150 and the second leg members 161 to 163 of the second core 160 are opposed to each other across gaps. A gap member may be disposed in the gap. A coil 171 is wound onto the first leg member 151 and the second leg member 161 in the vicinity of the gap. Coils 172 and 173 are wound in the same manner.

The first leg members 151 to 153 integrally have projection portions 151a to 153a at their outer end portions, respectively. In the first support member 155, recessed portions 156 to 158 into which the projection portions 151a to 153a can be fitted are formed. In the same manner, the second leg members 161 to 163 integrally have projection portions 161a to 163a at their outer end portions, respectively. In the second support member 165, recessed portions 166 to 168 into which the projection portions 161a to 163a can be fitted are formed. The first support member 155 and the second support member 165 are preferably formed by stacking a plurality of non-oriented magnetic steel sheets, and the first leg members 151 to 153 and the second leg members 161 to 163 are preferably formed by stacking a plurality of oriented magnetic steel sheets.

In this instance, the first support member 155 (first iron core block) and the first leg members 151 to 153 (second iron core blocks) are fitted with each other using the recessed portions 156 to 158 and the projection portions 151a to 153a. The second support member 165 (first iron core block) and the second leg members 161 to 163 (second iron core blocks) are fitted with each other using the recessed portions 166 to 168 and the projection portions 161a to 163a. Therefore, it is possible to prevent the occurrence of vibration or noise, in the same manner as above.

The reactors 5 are described with reference to the drawings, but this disclosure includes potential transformers having the same structure as above. Furthermore, this disclosure includes appropriate combinations of some of the above-described embodiments.

Aspects of Disclosure

A first aspect provides an iron core including a first iron core block (20) and a second iron core block (41-44). The first iron core block and the second iron core block include a recessed portion (71-74) and a projection portion (61-64), respectively, which are fitted with each other.

According to a second aspect, in the first aspect, a plurality of the second iron core blocks are disposed inside the ring-shaped first iron core block, and a coil (51-54) is wound onto each of the second iron core blocks.

According to a third aspect, in the second aspect, the first iron core block and the second iron core block include a plurality of outer peripheral core members (21-28) constituting a ring-shaped outer peripheral core.

According to a fourth aspect, in the second or third aspect, a through hole (91-93) is formed adjacent to the recessed portion and the projection portion.

According to a fifth aspect, in the second aspect, the number of the second iron core blocks around which the coils are wound is an integral multiple of 3.

According to a sixth aspect, in the second aspect, the number of the second iron core blocks around which the coils are wound is an even number of 4 or more.

### Advantageous Effects of the Aspects

According to the first aspect, the first iron core block and the second iron core block are fitted with each other using the recessed portion and the projection portion, without the need to use an adhesive, screws, or the like. In other words, a member having a different thermal expansion coefficient can be omitted. Therefore, a secured portion between the two iron core blocks does not deteriorate, even with long-term use, and it is therefore possible to prevent the occurrence of vibration or noise.

According to the second aspect, the iron core assembly can be used in a reactor.

According to the third aspect, the outer peripheral core can be easily produced, even if the outer peripheral core is large in size.

According to the fourth aspect, by inserting a bolt, a rod, or the like into the through hole, the first iron core block can be firmly secured in the stacking direction (axial direction) in the vicinity of the recessed portion and the projection portion.

According to the fifth aspect, the iron core assembly can be used in a three-phase reactor.

According to the sixth aspect, the iron core assembly can be used in a single-phase reactor.

The present invention is described above with reference to the preferred embodiments, but it is apparent for those skilled in the art that the above modifications and various other modifications, omissions, and additions can be performed without departing from the scope of the present invention.

What is claimed is:

1. An iron core comprising:
a first iron core block and a second iron core block;
wherein the first iron core block and the second iron core block include a recessed portion and a projection portion, respectively, which can be fitted with each other.

2. The iron core according to claim 1, wherein a plurality of the second iron core blocks are disposed inside the first iron core block, which is ring shaped, and a coil is wound onto each of the second iron core blocks.

3. The iron core according to claim 1, wherein the first iron core block and the second iron core block include a plurality of outer peripheral core members constituting a ring-shaped outer peripheral core.

4. The iron core according to claim 2, wherein a through hole is formed adjacent to the recessed portion and the projection portion.

5. The iron core according to claim 2, wherein the number of the second iron core blocks around which the coils are wound is an integral multiple of 3.

6. The iron core according to claim 2, wherein the number of the second iron core blocks around which the coils are wound is an even number of 4 or more.
